(19) United States
(12) Patent Application Publication
(10) Pub. No.: US 2017/0374154 A1
(43) Pub. Date: Dec. 28, 2017

(54) GENERATING A RESPONSE TO A CLIENT DEVICE IN AN INTERNET OF THINGS DOMAIN

(71) Applicant: HEWLETT PACKARD ENTERPRISE DEVELOPMENT LP, HOUSTON, TX (US)

(72) Inventor: Hugh Hamill, Galway (IE)

(21) Appl. No.: 15/190,513

(22) Filed: Jun. 23, 2016

(51) Int. Cl. H04L 29/08; H04L 29/12

(52) U.S. Cl. CPC H04L 67/125; H04L 61/1558; H04L 67/025

(57) ABSTRACT

The present disclosure relates to a method, system, and medium to generate a response to a client device in an IoT domain. The disclosed system can receive a request, which includes a resource parameter in a plural form, from a client device to retrieve information from an IoT API. The system then derives a singular form of the resource parameter. Also, the system inquires to the IoT API whether the singular form of the resource parameter is a valid object type in an IoT domain. If so, the system retrieves information about a plurality of objects corresponding to the valid object type, and generates a response comprising the information about the plurality of objects to the client device.

### BACKGROUND

A Internet of Things (IoT) may refer to technology to allow devices that may provide information over networks. Specifically, the IoT includes a network of physical objects, such as, devices, vehicles, buildings and other items, embedded with electronics, software, sensors, and network connectivity that allows these objects to collect and exchange data. The IoT allows objects to be sensed and controlled remotely across existing network infrastructure with more direct integration of the physical world into computer-based systems.

### BRIEF DESCRIPTION OF THE DRAWINGS

The following detailed description references the drawings, wherein:

FIG. 1 is a block diagram of an example environment for an IoT model in which a domain-specific REST controller is deployed;

FIG. 2 is a block diagram of an example response generation using the domain-specific REST controller corresponding to a request for a collection of resource endpoints;

FIG. 3 is a block diagram of an example response generation using the domain-specific REST controller corresponding to a request for an individual resource endpoint;

FIGS. 4A-4B show an example response generation using the domain-specific REST controller corresponding to a request for a collection of related resource endpoints;

FIGS. 5A-5B show an example response generation using the domain-specific REST controller corresponding to a request for a collection of nested message resource endpoints;

FIGS. 6A-6B show example response generation using the domain-specific REST controller corresponding to a request for a nested individual resource endpoint;

FIG. 7 is a flowchart of an example process to generate a response to a client device in an IoT domain;

FIG. 8 is a flowchart of an example process to generate a response to a client device in an IoT domain;

FIG. 9 is a flowchart of an example process to generate a response to a client device in an IoT domain; and

FIG. 10 is a block diagram of an example network device to generate a response to a client device in an IoT domain.

### DETAILED DESCRIPTION

A generic Internet of Things (IoT) model generally contains the following blocks: ThingType, which describes a class model for defining IoT classes and attributes; ThingformationType, which describes a class model for defining IoT messaging classes and attributes; RelationshipType, which describes a class model for defining IoT inter-Thing or inter-Thingformation relationships; Thing, which describes an instance model for IoT object instances; Thingformation, which describes an instance model for IoT messaging instances; and Relationship, which describes an instance model for IoT relationship instances. Such generic IoT model does not provide domain-specific representational state transfer (REST) application programming interface (API). Therefore, it is difficult for client developers and client applications to work with the generic IoT model.

Given the generic IoT model, a domain-specific controller according to the present disclosure may dynamically serve this model in a domain-specific REST API. It may expose a collection of resource endpoints encoded using the Hypertext Application Language (HAL) format at the root (‘/’) of the REST API, which are based on the pluralized names of the ThingType objects defined in the IoT model. The disclosed domain-specific controller also transforms and exposes both Things and Thingformation as domain-specific individual and collection resource representations with attributes and Hypermedia as the Engine of Application State (HATEOAS) links. It will generate HATEOAS Links in a given resource to domain-specific message collection endpoints or related resource individual or collection endpoints using domain-specific Rels for Thingformation message types in the IoT domain. Changes in the underlying IoT domain are immediately reflected by the domain-specific controller to interacting client code, without restarting the domain-specific API application or incurring any downtime.

Overview

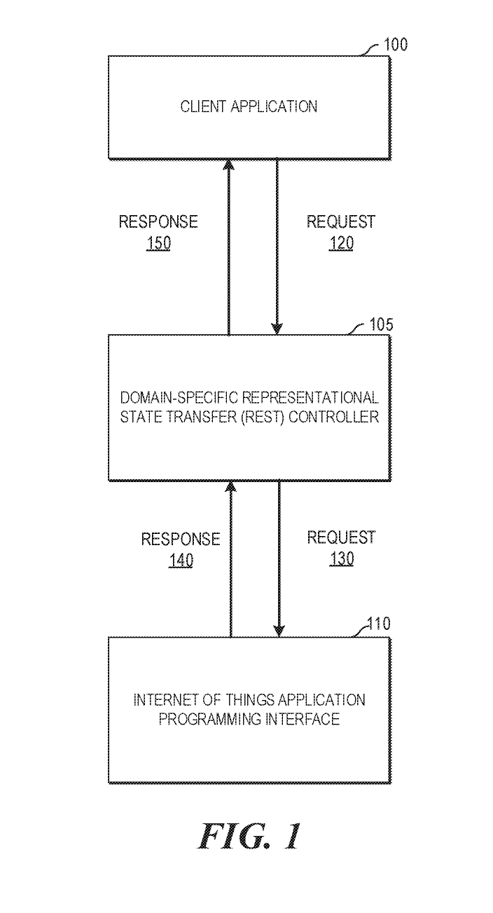

FIG. 1 shows a block diagram of an example environment for an IoT model, in which a domain-specific REST controller is deployed. In FIG. 1, Client Application 100 makes a request 120 to a domain-specific REST controller 105. Domain-specific REST controller 105 then interacts with a generic Internet of Things (IoT) API 110 to produce a response for an IoT client. Specifically, domain-specific REST controller 105 sends a request 130 to IoT API 110 and receives a generic response (e.g., response 140) from IoT API 110. Then, domain-specific REST controller 105 generates a domain-specific response (e.g., response 150) based on the generic response (e.g., response 140) received from IoT API 110. Note that in some cases, domain-specific REST controller 105 may send multiple requests (e.g., multiple requests 130) to IoT API 110 and receive multiple responses (e.g., responses 140) in order to generate a response (e.g., response 150) to a request (e.g., request 120) received from client application 100.

As used throughout this disclosure, “ThingType” generally describes a class model for defining IoT classes and attributes; “ThingformationType” generally describes a class model for defining IoT messaging classes and attributes; “RelationshipType” generally describes a class model for defining IoT inter-Thing or inter-Thingformation relationships; “Thing” generally describes an instance model for IoT object instances; “Thingformation” generally describes an instance model for IoT messaging instances; and “Relationship” generally describes an instance model for IoT relationship instances.

Entry Points and End Points

Table 1 below shows an example response generated by the domain-specific REST controller.

TABLE 1
Example Entry Point Response

{

“_links”: {

“Racks”: {

“href”: “http://localhost:8000/Racks”

},
“Devices”: {

“href”: “http://localhost:8000/Devices”

},
“GraphicsCards”: {

“href”: http://localhost:8000/GraphicsCards”

}

}

}

This response includes the entry points to the domain-specific REST API. When a user makes a request using a root Uniform Resource Locator (URL) in the domain-specific REST API (e.g., http://localhost:8000/), the user will receive a response, such as the response shown in Table 1. Then, the user can follow each a series of links to view end points at various levels. In this example, the user can view the Racks in the system by following the HAL link generated for Rack, which is http://localhost:8000/Racks. Likewise, the user can view the Devices in the system by following the HAL link generated for Device, which is http://localhost:8000/Devices. Also, the user can view the GraphicsCards in the system by following the HAL link generated for GraphicsCard, which is http://localhost:8000/GraphicsCards.

Generally, a REST application has a limited set of entry points. The set of entry points includes links where a client uses to start the REST application. The client then reaches other resources in the REST application by following a series of links in the response map returned from an entry point. In some implementations, the entry points may represent top level resources (e.g., http://localhost:8000/Racks may be the root URL for the Rack type resources; http://localhost:8000/Devices may be the root URL for the Device type resources; http://localhost:8000/GraphicsCards may be the root URL for the GraphicsCard type resources). In some implementations, the entry points may represent ThingformationTypes (e.g., Statuses, Events, Messages, etc.) instead of ThingTypes (e.g., Racks, Devices, GraphicsCards, etc.).

The present disclosure describes how to generate an IoT domain-specific response corresponding to a request for an end point from a user using generic content information received from a generic IoT API.

Resource Collection Endpoints

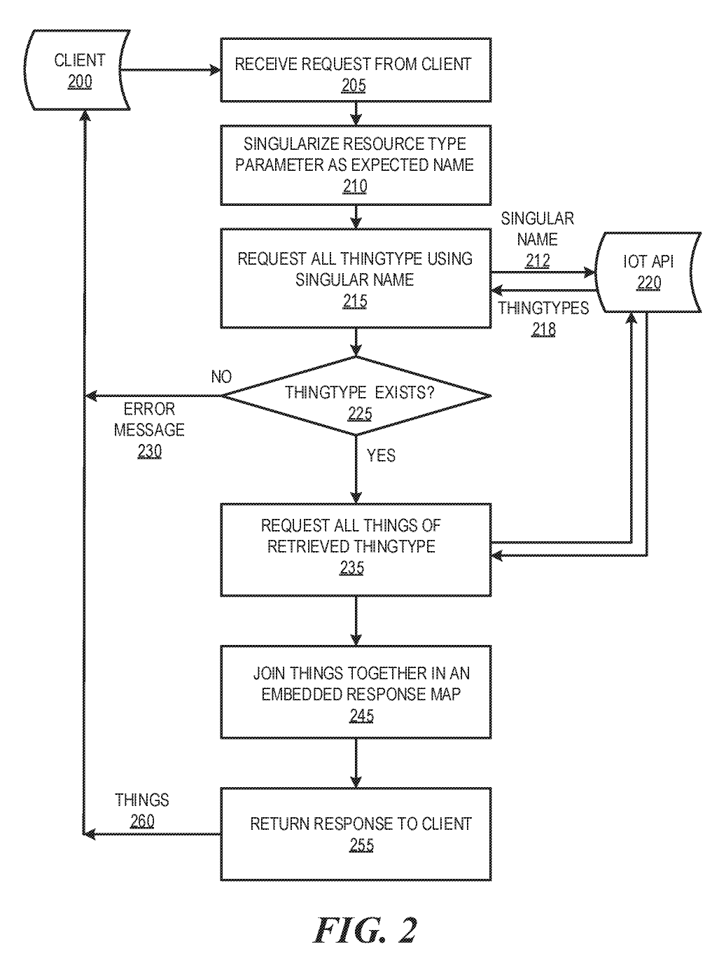

Referring to FIG. 2, a client device 200 makes a request to the domain-specific REST controller for a collection of resource endpoints in the domain-specific API. For example, the request may be in the form of a root URL corresponding to the entry point appended by “/{pluralName},” e.g., http://localhost:8000/Racks. The domain-specific REST controller receives the above request from the client device at 205. Next, the domain-specific REST controller uses an inflector to singularize the resource type parameter (e.g., {pluralName}) as an expected name (e.g., “Racks”) at 210. Furthermore, the domain-specific REST controller interacts with a generic IoT API 220 to produce a response for client device 200. In particular, the domain-specific REST controller requests a ThingType using the singular name (e.g., “Rack”) from the generic IoT API 220. Specifically, the domain-specific REST controller may execute the following example query to request the ThingType from the generic IoT API: http://localhost:8080/thingTypes/search/findbyName?name=Rack. Note that the resource parameter uses the singular name (e.g., “Rack”) here.

When the generic IoT API 220 receives a singular name 212, it will return a ThingType 218 that matches the singular name 212. Then, at 225, the domain-specific REST controller determines whether the ThingType exists based on the response from IoT API. If the ThingType does not exist, the domain-specific REST controller returns an error message 230 (e.g., a 404 “Not Found” HTTP Response) to the calling client (e.g., Client 200).

On the other hand, if the ThingType does exist, then at 235, the domain-specific REST controller makes a request for all Things of retrieved ThingType to the IoT API. The domain-specific REST controller can do so by following the link to the Things in the response corresponding to the ThingType 218, e.g., http://localhost:8080/thingTypes/1/things.

Moreover, at 245, the domain-specific REST controller retrieves information about the returned Things, and joins them together in an “embedded” map with a key (e.g., “Racks”), which is the plural name of the ThingType as per HAL standard. Next, the domain-specific REST controller returns an HTTP response to the client at 255. The HTTP response includes Things 260.

TABLE 2
Example Resource Collection Endpoint Response

{

“_embedded” {

“Racks”: [
{

“serialNo”: “1234”,
“_links” {

“self”: {

“href”: http://localhost:8000/Rack/1

},
“Devices”: {

“href”: http://localhost:8000/Rack/1/Devices”

}

}

}]}}

An example of the HTTP response is shown in Table 2 above when a client requests for the endpoint http://localhost:8000/Racks. Note that although the resource collection in this example only includes Things, the domain-specific REST controller can generate a response for Thingformations in the same fashion if the client 200 requests for the Thingformations endpoints (e.g., http://localhost:8000/statuses).

Individual Resource Endpoint

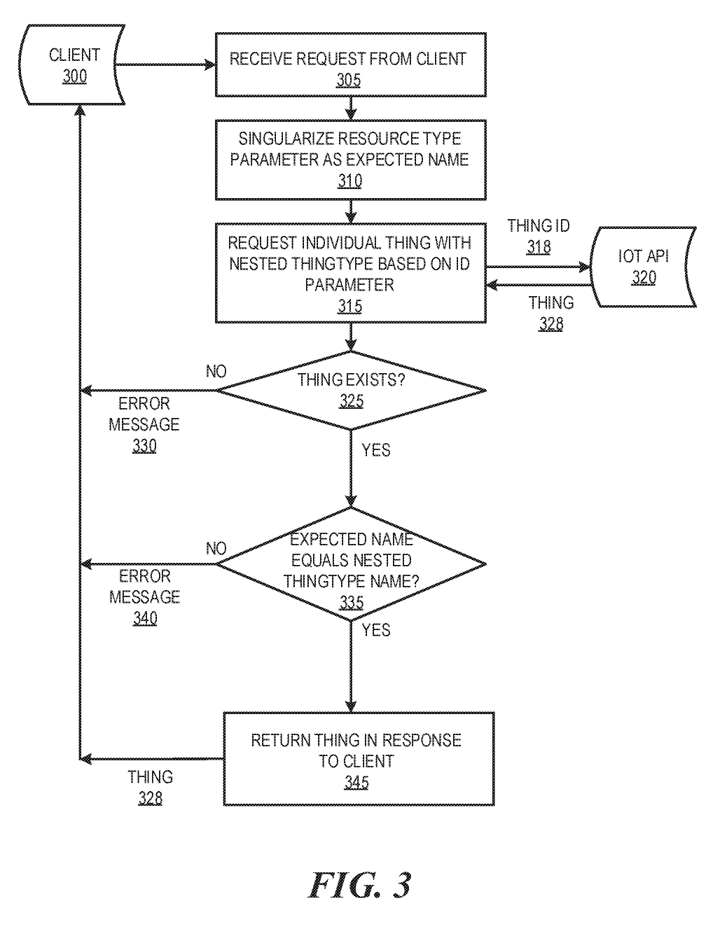

Referring now to FIG. 3, a client device 300 makes a request to the domain-specific REST controller for an individual resource endpoint in the domain-specific API. For example, the request may be in the form of a root URL corresponding to the entry point appended by “/{pluralName}” and a Thing identifier “/{id}”, e.g., http://localhost:8000/Devices/1. The client device 200 may request information about a particular device with thing identifier equals to 1 using the above URL from the domain-specific REST API.

The domain-specific REST controller receives the above request from the client device at 305. Next, the domain-specific REST controller uses an inflector to singularize the resource type parameter (e.g., {pluralName}) as an expected name (e.g., “Devices”) at 310.

Then, at 315, the domain-specific REST controller makes a request for the individual thing with nested ThingType based on the identifier parameter {id}. For example, the request may be in the form of http://localhost:8080/things/2. In response to such request, the IoT API 320 will return an expanded representation of a Thing 328 that matches the Thing ID 318. In some implementations, the returned Thing 328 also includes a nested ThingType.

At 325, the domain-specific REST controller determines whether the requested individual Thing exists. If the Thing does not exist, the domain-specific REST controller returns an error message 330 (e.g., a 404 “Not Found” HTTP Response) to the calling client (e.g., Client 300).

On the other hand, if the Thing does exist, the domain-specific REST controller further determines whether the expected name equals the nested ThingType name at 335. To do so, the domain-specific REST controller follows the ThingType link (e.g., http://localhost:8080/things/2/thingType) in the response from the generic IoT API to the query based on the Thing ID 318. In this example, the ThingType of the thing with identifier 2 is a Device. Therefore, the singularized resource type parameter (“Device” as derived from “Devices”) matches the name of the nested ThingType (“Device” corresponding to the thing whose identifier is 2).

If the Thing exists but the singularized resource type parameter does not match the name of the nested ThingType (e.g., http://localhost:8000/Racks/2), then the domain-specific REST controller also returns an error message 340 (e.g., 404 “Not Found” HTTP Response) to the calling client (e.g., Client 300). Note that, the domain-specific REST controller returns error message 340 in this example, because the thing with identifier 2 is a Device rather than a Rack in the system. On the other hand, if the Thing exists and the singularized resource type parameter matches the name of the nested ThingType, then the domain-specific REST controller returns the Thing 328 in an HTTP response to the client device at 345. An example HTTP response for individual resource endpoint is shown below in Table 3.

TABLE 3
Example Individual Resource Endpoint Response

```
{
  “ip”: “127.0.0.1”,
  “hdd”: “80%”
  “_links” {
```

```
“self”: {
  “href”: “http://localhost:8000/Devices/2”
},
“GraphicsCards”: {
  “href”: “http://localhost:8000/Devices/2/GraphicsCards”
},
“Rack”: {
  “href”: “http://localhost:8000/Devices/2/Rack”
},
“Statuses”: {
  “href”: “http://localhost:8000/Devices/2/Statuses”
},
“SystemReboots”: {
```

“href”: “http://localhost:8000/Devices/2/SystemReboots”

}

}
}

Related Resource Collection Endpoints

In an IoT API, individual Things can be related to each other. For example, a rack can include a plurality of devices; and, a device can include a plurality of graphics cards. In this manner, a rack, a device, and graphics cards can be related to each other. This section describes the generation of resource contents in response to requests for such related resources.

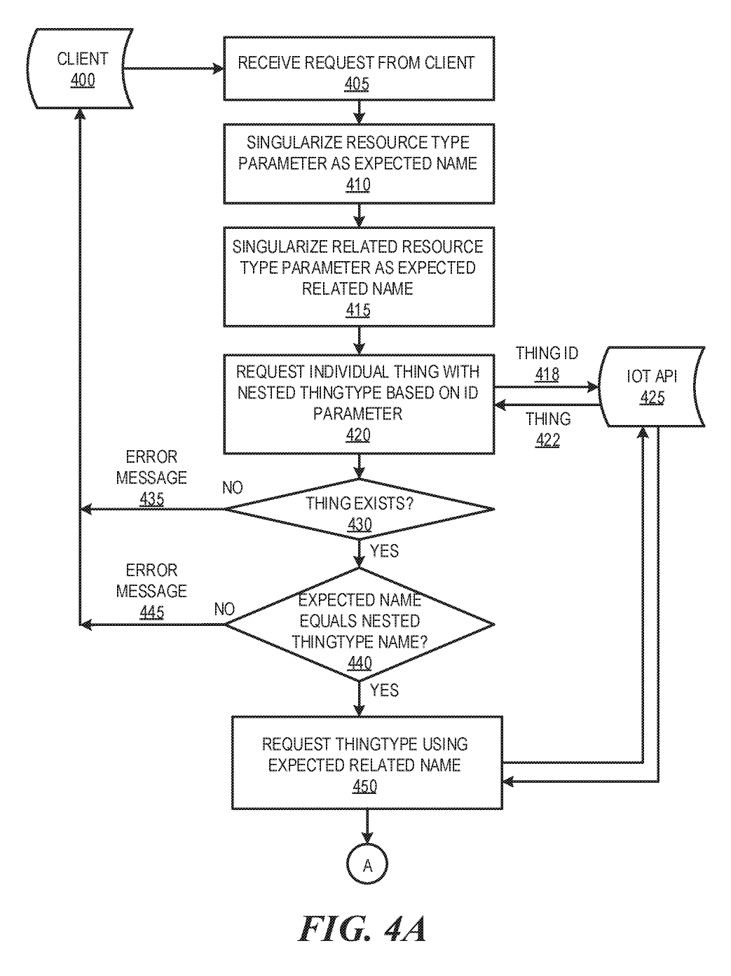

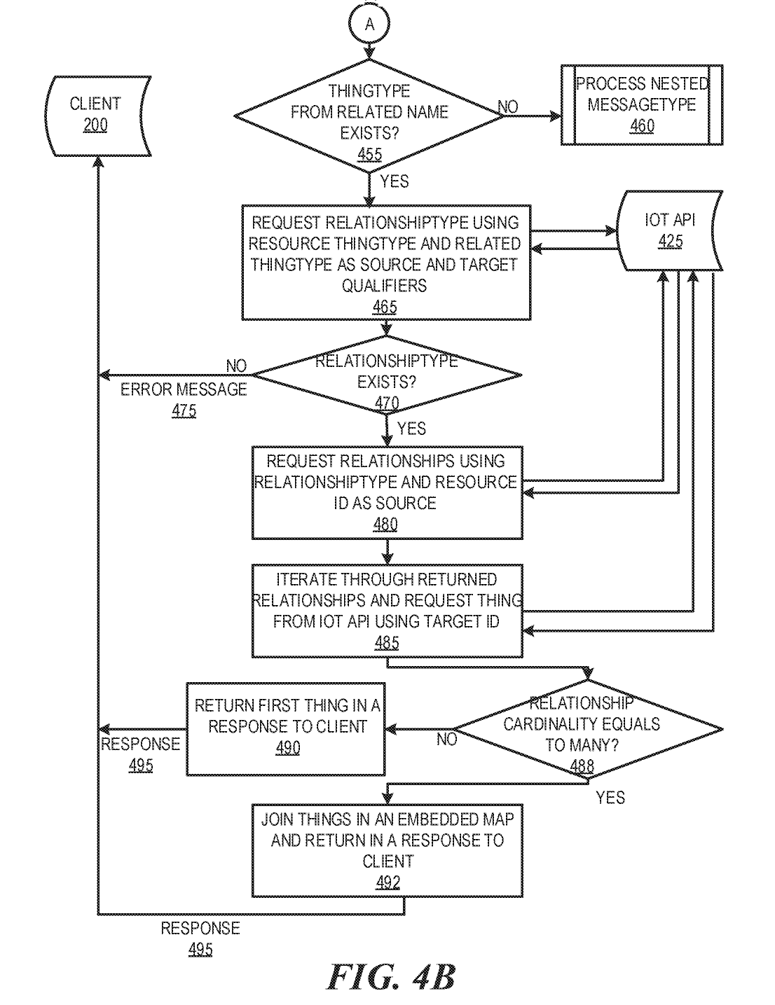

FIGS. 4A-4B are block diagrams of example generation of response including resource information of related things using the domain-specific REST controller. FIGS. 4A-4B include a client 400 and a generic IoT API 410. The response generation of resource information begins when client 400 makes an HTTP request to a domain-specific REST controller. The request for the related collection resource endpoint in the domain specific API may include “/{pluralName}/{id}/{relatedName},” e.g., http://localhost:8000/Devices/2/GraphicsCards. Client 400 can use the above request to view all graphics cards that belong to the device with the thing identifier 2.

The domain-specific REST controller receives the request from client at 405, and interacts with the IoT API 425 to produce a response for client 400. Specifically, the domain-specific controller uses an inflector to singularize the resource type parameter {pluralName} (e.g., “Devices”) as expected name (e.g., “Device”) at 410. Moreover, the domain-specific controller singularizes the related resource type parameter {relatedName} (e.g., “GraphicsCards”) as expected related name (e.g., “GraphicsCard”) at 415. Then, the domain-specific REST controller makes a request to the IoT API 425 to retrieve the individual Thing 422 with nested ThingType based on the Thing ID parameter {id} 418 (e.g., 2) at 420.

At 430, the domain-specific REST controller determines whether the requested individual Thing exists. If the Thing does not exist, the domain-specific REST controller returns an error message 435 (e.g., a 404 “Not Found” HTTP Response) to the calling client (e.g., Client 400).

On the other hand, if the Thing does exist, the domain-specific REST controller further determines whether the expected name equals the nested ThingType name at 440. To do so, the domain-specific REST controller follows the ThingType link (e.g., http://localhost:8080/things/2/thingType) in the response from the generic IoT API 425 to the query based on the Thing ID 418. If the Thing does exist in the IoT API 425, but the expected name does not equal to the nested ThingType name, then an error message 445 (e.g., 404 “Not Found” HTTP response) is returned to client 400.

If the Thing exists in the IoT API 425 and the expected name equals to the nested ThingType name, then the domain-specific REST controller makes a request to the IoT API 425 to retrieve a ThingType using the expected related name (e.g., “GraphicsCard”) as ThingType name at 450.

Next, the domain-specific REST controller determines whether the ThingType from related name exists at 455. If no ThingType matches the expected related name, the domain-specific REST controller switches to process the request as a request for a nested message resource at 460.

If, on the other hand, a matching ThingType is found, the domain-specific REST controller makes a request to the IoT API 425 to retrieve a RelationshipType using the resource ThingType as a source qualifier and the related resource ThingType as a target qualifier at 465. Here, the ThingType identifier corresponding to Devices is 2, and the ThingType identifier corresponding to GraphcsCards is 3. Therefore, an example request from the domain-specific REST controller to the IoT API 425 can be http://localhost:8080/relationshipTypes/search/findBySourceQualifierTypeAndSourceQualifierIdAndTargetQualifierTypeAndTargetQualifierId?sourceQualifierType=THING_TYPE&sourceQualifierId=2&targetQualiferType=THING_TYPE&targetQualifeirId=3. In response to the above query, the IoT API 425 will return all RelationshipTypes where the source is a device and the target is a graphics card. An example response from the IoT API 425 is shown in Table 4 below.

TABLE 4
Example RelationshipType Response from Generic IoT API

{
“ embedded” {

```
“relationshipTypes”: {
  “identifier”: 1,
  “cardinality”: “MANY”,
  “sourceType”: “THING”,
  “targetType”: “THING”,
  “sourceQualifierType”: “THING_TYPE”,
  “targetQualifierType”: “THING_TYPE”,
  “sourceQualifierId”: 2,
  “targetQualifierId”: 3,
  “qualified”: true,
  “attribute”: null,
  “_links”: {
```

```
“self”: {
  “href”: “http://localhost:8080/relationshipTypes/3”
},
“sourceQualifier”: {
  “href”: “http://localhost:8080/thingTypes/2”
},
“targetQualifier”: {
  “href”: “http://localhost:8080/thingTypes/3”
},
“relationships”: {
  “href”:
```

“http://localhost:8080/relationshipTypes/3/relationships”

}

}
}

```
  ]
  }
```

Then, at 470, the domain-specific REST controller determines whether the RelationshipType corresponding to the source qualifier and the target qualifier exists. If no RelationshipType is found, then the domain-specific REST controller returns an error message 475 (e.g., a “Not Found” or “404” HTTP response) to client 400.

If a RelationshipType is found, then at 480, the domain-specific REST controller makes a request for all the Relationships of that RelationshipType where the Source object of the Relationships is the Thing previously retrieved using the ID parameter. Specifically, the domain-specific REST controller can do so by following the relationships link (e.g., http://localhost:8080/relationshipTypes/3/relationships) in the RelationshipType response from the generic IoT API 425. The IoT API 425 will return a plurality of relationships, which include any relationship that maps a device to a graphics card.

At 485, the domain-specific REST controller iterates through returned Relationships and make a request for the target Thing (e.g., “GraphicsCard”) to the IoT API 425 for each relationship. Specifically, the domain-specific REST controller filters the plurality of relationships based on the source qualifier identifier. In the above example, it will look for the relationships where the source qualifier ID is 2, which corresponds to a device ThingType. For each of such relationship whose source qualifier ID is 2, the domain-specific REST controller follows the target link in the response (e.g., http://localhost:8080/things/5{?projection}) to retrieve information about the related resource.

In some implementations, instead of following the relationships link, if a RelationshipType is found, the domain-specific REST controller can execute a query using the RelationshipType identifier and the source qualifier identifier, e.g., http://localhost:8080/relationships/search/findByRelatioshipTypeAndSourceId?type=3&sourceId=2.

Furthermore, the domain-specific REST controller determines whether the RelationshipType cardinality equals “MANY” at 488. If the RelationshipType cardinality does not equal to “MANY” (e.g., the RelationshipType cardinality equals to “ONE”), then at 490, the first Thing is returned in an HTTP response 495 to client 400. If the RelationshipType cardinality equals “MANY,” then at 492, the domain-specific REST controller will join Things together in an “embedded” response map, where the key of the map is the pluralized name of the nested resource ThingType as per HAL standard, and will return the response map in an HTTP response 495 to client 400. An example response for individual resource endpoint is shown in Table 5.

Note that, if the RelationshipType cardinality is “MANY,” the nested resource name will be pluralized, e.g., http://localhost:8000/Devices/2/GraphicsCards. On the other hand, if the RelationshipType cardinality is “ONE,” then the nested resource name is not pluralized, e.g., http://localhost:8000/Devices/2/Rack.

TABLE 5
Example Related Resource Endpoint Response

{

```
“_embedded”: {
    “GraphicsCards”: [
    {
```

```
  “VRAM”: “32GB”,
  “Mode”: “SLI”,
  “Manufacture”: “NVidia”,
  “GPU”: “2.4GHz”,
  “_links”: {
    “self”: “http://localhost:8000/GraphicsCards/5”
    },
  “Device”: {
```

“href”: “http://localhost:8000/GraphicsCards/5/Deivce”
},

“OverHeats”: {

“href”:

“http://localhost:8000/GraphicsCards/5/OverHeats”

}

}
},

```
{
  “VRAM”: “64GB”,
  “Mode”: “SLI”,
  “Manufacture”: “NVidia”,
  “GPU”: “3.1GHz”,
  “_links”: {
    “self”: “http://localhost:8000/GraphicsCards/6”
    },
  “Device”: {
```

“href”: “http://localhost:8000/GraphicsCards/6/Deivce”
},

“OverHeats”: {

“href”: “http://localhost:8000/GraphicsCards/6/OverHeats”
}

}
}
]

}
}

Nested Message Resource Collection Endpoints

A top-level resource generally refers to an individual or collection of resource that can be accessed by appending the resource information (e.g., type and identifier) to the root URL. For example, http://localhost:8000/devices/2 points to a top-level resource that is an individual device. The top-level resource is a global object and its existence does not depend on the existence of any other objects. On the other hand, a nested resource generally refers to a second level resource that is related to a top-level resource. For example, http://localhost:8000/devices/2/Statuses points to a collection of status messages that are associated with a particular device. Although there might be many status messages existing in the IoT domain, the above link will only show statuses that are related to a particular device (e.g., belonging to the device with identifier number 2). In other words, nested message resources can be considered as resources that are filtered based on their relationship with an individual or collection of top-level resources.

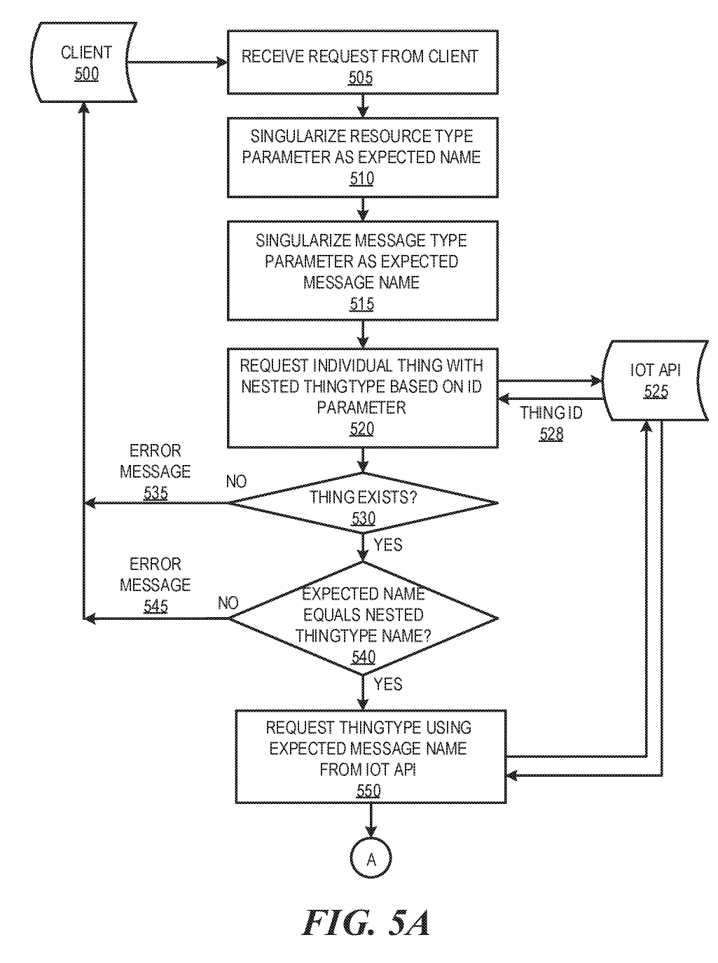

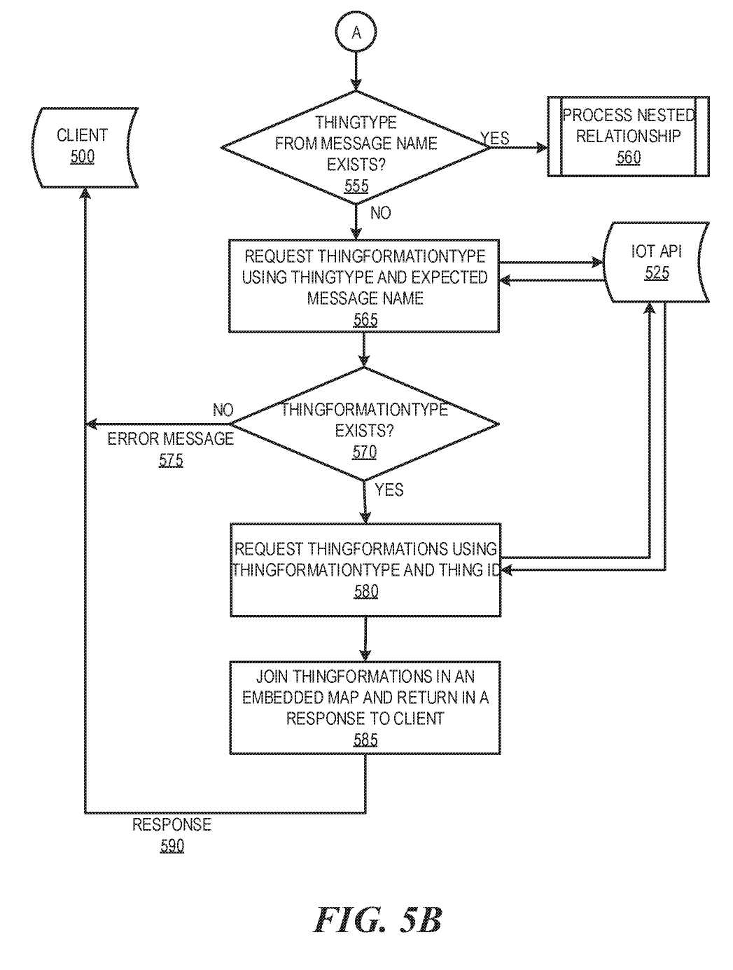

Referring now to FIGS. 5A-5B, the response generation of nested message resource collection endpoints begins when a client 500 makes an HTTP request (“/{pluralName}/{id}/{pluralMessageName}”) to the domain-specific REST controller. At 505, the domain-specific REST controller receives the request from the client device 500. The domain-specific REST controller then interacts with the IoT API 525 to generate a response for client 500.

Specifically, at 510, the domain-specific REST controller uses an inflector to singularize the resource type parameter (e.g., {pluralName}) as expected name (e.g., “Devices”) at 510. Moreover, the domain-specific REST controller singularizes the message type parameter (e.g., {pluralMessageName}) as expected message name (e.g., “Statuses”) at 515. Then, the domain-specific REST controller then makes a request to the generic IoT API 525 to retrieve the individual Thing with nested ThingType based on the Thing ID parameter (e.g., {id}) at 520.

Next, the domain-specific REST controller determines whether the thing corresponding to the identifier parameter {id} exists at 530. If the thing does not exist in the IoT API 525, then the domain-specific REST controller returns an error message 535 (e.g., a “Not Found” and/or “404” HTTP response) to client 500.

Moreover, the domain-specific REST controller determines whether the expected name equals to the nested ThingType name at 540. If the Thing does exist in the generic IoT API 525 but the expected name does not equal to the nested ThingType name, then the domain-specific REST controller returns an error message 545 (e.g., a “Not Found” and/or “404” HTTP response) to client 500.

If the Thing exists in the IoT API and the expected name equals to the nested ThingType name, then the domain-specific REST controller makes a request to the IoT API 525 to retrieve a ThingType using the expected message name as ThingType name at 550. In particular, the domain-specific REST controller requests an individual Thing using the expected message name (e.g., “status”) from the generic IoT API 525.

At 555, the domain-specific REST controller determines whether a ThingType matching the message name exists. If so, the domain-specific REST controller switches to processing the request as a request for a nested relationship resource 560.

Otherwise, the domain-specific REST controller request ThingformationType from IoT API 525 using the ThingType and expected message name at 565. For example, the domain-specific REST controller may execute the following example query to the generic IoT API 525: http://localhost:8080/thingformationTypes/search/findbyNameAndThingType?name=Status&thingType=2. Note that the message type parameter uses the singular name (e.g., “status”) here. Also, the ThingType identifier (e.g., “2”) corresponds to the Thing (e.g., “Device”). The above query will return a response that includes a ThingformationType identifier (e.g., “1”), which corresponds to statuses associated with a particular device whose thing identifier is 2.

Then, the domain-specific REST controller determines whether ThingformationType exists at 570. If a matching ThingformationType does not exist, the domain-specific REST controller returns an error message 575 (e.g., a “Not Found” and/or “404” HTTP response) to client 500. However, if a matching ThingformationType is found, then the domain-specific REST controller request Thingformations from the generic IoT API 525 using ThingformationType and Thing ID at 580. For example, the domain-specific REST controller further executes the following example query to the generic IoT API 525: http://localhost:8080/thingformations/search/findbyThingformationTypeAndThing?thingformationType=1&thing=2.

Thereafter, at 585, the domain-specific REST controller joins Thingformations in an embedded map and returns the embedded map in a response 590 to client 500. An example response for nested message resource collection endpoint is shown in Table 6 below.

TABLE 6
Example Nested Message Resource Collection Endpoint Response

{
“_embedded”: {

“Statuses”: [
{

“text”: “OK”,
“Device”: {

“hdd”: “90%”

},

“_links” {

“self”: {
“href”: http://localhost:8000/Devices/2/Statuses/1”
},
“Device”: {

“href”: “http://localhost:8000/Devices/2”

}

```
    }
  },
  {
```

“text”: “WARNING”,
“Device”: {

“hdd”: “99%”

},

“_links” {

```
“self”: {
  “href”: http://localhost:8000/Devices/2/Statusus/2”
},
“Device”: {
  “href”: “http://localhost:8000/Devices/2/”
  }
```

```
  }
  }
]
```

}
}

Nested Individual Message Resource Endpoint

The domain-specific REST controller can dynamically expose individual resource representations for messages at a nested resource endpoint of the REST API. The individual message resource representation uses, for example, a plural resource type name, an individual resource identifier, a plural message type name, and individual message identifier to create the unique endpoint (“/{pluralName}/{id}/{pluralMessageName}/{messageId}”). Here, the name of the resource type {pluralName} refers to the pluralized name of a ThingType in the IoT domain; the identifier {id} refers to the identifier of an individual Thing of that ThingType in the IoT domain; the name of the nested resource collection {pluralMessageName} refers to the pluralized name of a ThingformationType related to the ThingType in the IoT domain; and, the message identifier {messageId} refers to the identifier of an individual Thingformation of that ThingformationType in the IoT domain. The returned resource representation is the Thingformation as identified by appropriate ThingType, Thing ID, ThingformationType, and Thingformation ID from the IoT domain.

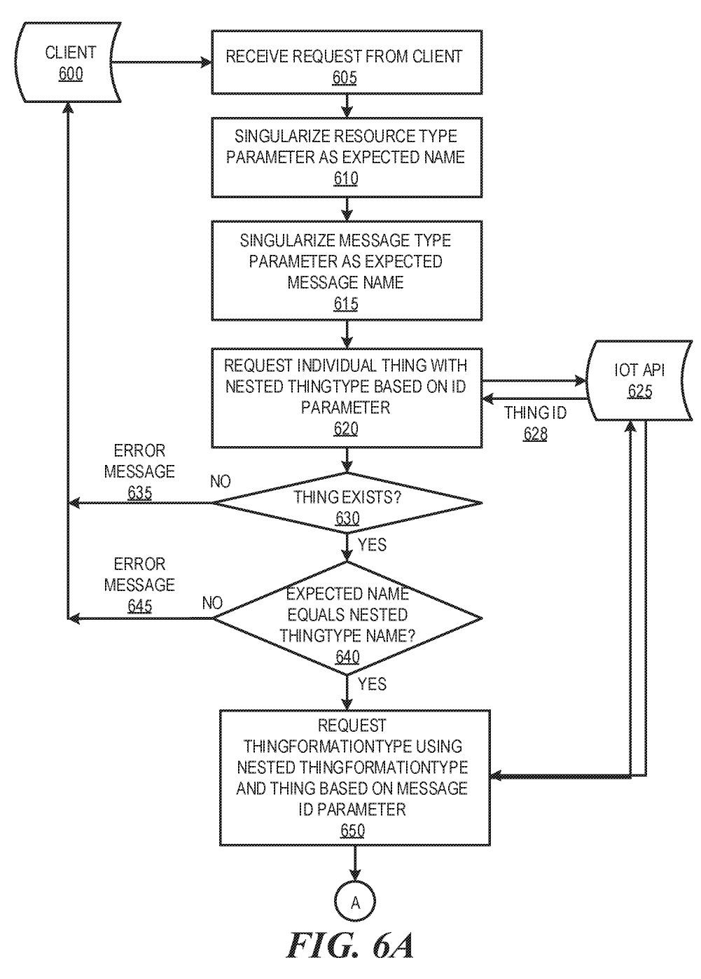

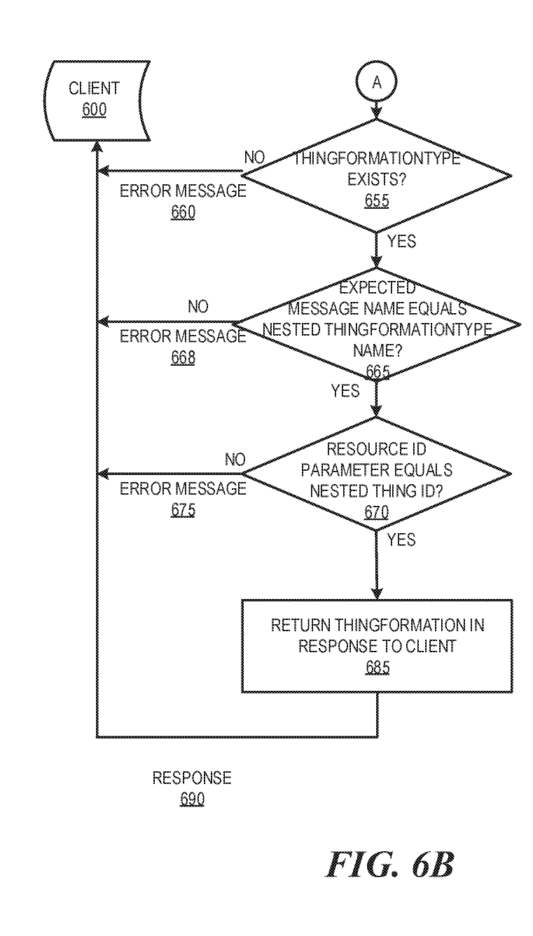

With reference to FIGS. 6A-6B, client 600 makes a request for the nested individual message resource endpoint (e.g., “/{pluralName}/{id}/{pluralMessageName}/{messageId}”) to the domain-specific REST controller. For example, the request may be http://localhost:8000/Devices/2/Statuses/1. The above request is for a particular status message whose identifier value of 1 about a device whose Thing identifier is 2.

The domain-specific REST controller then interacts with the generic IoT API 625 to generate a response for client 600. Specifically, the domain-specific REST controller receives the request from client 600 at 605. Then, the domain-specific REST controller uses an inflector to singularize the resource type parameter (e.g., {pluralName}) as expected name at 610. Further, the domain-specific REST controller also singularizes the message type parameter (e.g., {pluralMessageName}) as expected message name 615.

The domain-specific REST controller then makes a request to the IoT API 625 to retrieve the individual Thing with nested ThingType based on the resource identifier parameter (e.g., {id}) at 620. Based on the Thing ID 628 returned from IoT API 625, the domain-specific REST controller determines whether the Thing exists at 630. If the thing does not exist in the IoT API, then domain-specific REST controller returns an error message 635 (e.g., a “Not Found” and/or “404” HTTP response) to client 600.

If the Thing does exist in the IoT API, then the domain-specific REST controller further determines whether the expected name equals to the nested ThingType name at 640. If the Thing exists but the expected name does not equal to the nested ThingType name, then the domain-specific REST controller returns an error message 635 (e.g., a “Not Found” and/or “404” HTTP response) to client 600. Therefore, the domain-specific REST controller verifies that the thing corresponding to ThingType identifier value of 2 is actually a device before proceeding with any further processing.

If the Thing exists in the IoT API and the expected name equals to the nested ThingType name, then the domain-specific REST controller makes a request to the IoT API 625 to retrieve a ThingformationType with nested ThingformationType and Thing based on the message identifier parameter (e.g., {messageId}) at 650. Next, the domain-specific REST controller determines whether a matching ThingformationType exists at 655. If no matching ThingformationType is retrieved, the domain-specific REST controller returns an error message 660 (e.g., a “Not Found” and/or “404” HTTP response) to client 600.

If, however, a matching ThingformationType is retrieved, the domain-specific REST controller further determines whether the expected message name equals the nested ThingformationType name at 665. If a matching ThingformationType is retrieved, but the expected message name does not equal to the nested ThingformationType name, then the domain-specific REST controller returns an error message 668 (e.g., a “Not Found” and/or “404” HTTP response) to client 600. Therefore, the domain-specific REST controller verifies that the message corresponding to ThingformationType identifier value of 1 is actually a status before proceeding with any further processing.

In addition, the domain-specific REST controller determines whether the resource identifier parameter equals to the nested Thing identifier at 670. If the expected message name equals to the nested ThingformationType name, but the resource identifier parameter does not match the nested Thing identifier, then domain-specific REST controller returns an error message 675 (e.g., a “Not Found” and/or “404” HTTP response) to client. Therefore, the domain-specific REST controller verifies that the message corresponding to ThingformationType identifier value of 1 actually belongs to the thing corresponding to ThingType identifier value of 2 before any further processing. Thus, if client 600 sends a request to the domain-specific REST controller for http://localhost:8000/Racks/1/Statuses/1, client 600 will receive an error message, because the status with identifier 1 does not belong to a rack with identifier 1. Note that, here, client 600 receives the error message despite that the Thingformation identifier 1 matches to a status and the Thing identifier 1 matches to a rack.

If the resource identifier parameter matches the nested Thing identifier, then at 685, the information about the Thingformation is returned in a HTTP response 690 to the client 600. An example response for nested individual message resource endpoint is shown in Table 7 below.

TABLE 7
Nested Individual Message Resource Endpoint Response

{

“text”: “OK”,
“Device”: {

“hdd”: “90%”

},
“_links”: {

“self”: {

“href”:

“http://localhost:8000/Devices/2/Statuses/1”

},
“Device”: {

“href”: “http://localhost:8000/Devices/2”

}

}

}

Processes to Generate a Response to a Client Device in an IoT Domain

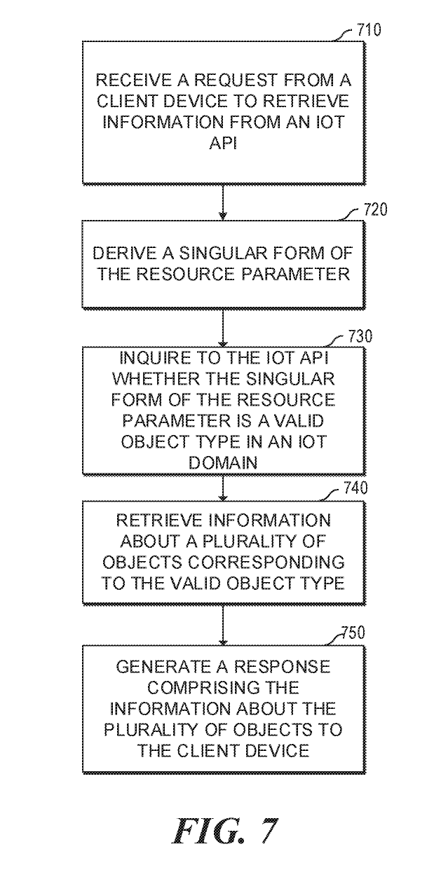

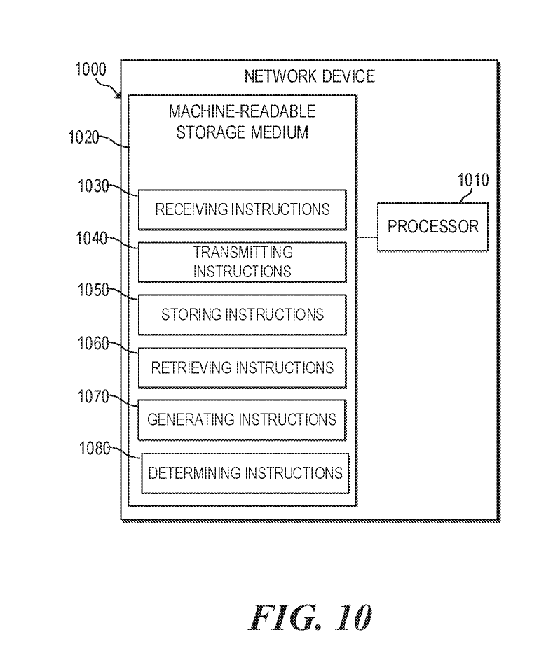

In discussing FIGS. 7-9, references may be made to the components in FIGS. 1-6 to provide contextual examples. In one implementation, the domain-specific REST controller 105 as in FIG. 1 executes operations 710-750 to generate a response to a client device in an IoT domain. In one implementation, the domain-specific REST controller 105 as in FIG. 1 executes operations 810-870 to generate a response to a client device in an IoT domain. In one implementation, the domain-specific REST controller 105 as in FIG. 1 executes operations 910-960 to generate a response to a client device in an IoT domain. Further, although FIGS. 7-9 are described as implemented by a controller, it may be executed on other suitable components. For example, FIGS. 7-9 may be implemented in the form of executable instructions on a machine-readable storage medium 1020 as in FIG. 10.

FIG. 7 is a flowchart of an example process to generate a response to a client device of an IoT domain using domain-specific REST controller. First, a computing device (e.g., the domain-specific REST controller) receives a request from a client device to retrieve information from an Internet of Things (IoT) Application Programming Interface (API) (operation 710).

Further, the computing device derives a singular form of the resource parameter (operation 720). Note that the request includes at least a resource parameter in a plural form. Moreover, the IoT API is a generic IoT API. In some implementations, the resource parameter includes a pluralized object type name. For example, the request may include a uniform resource locator (URL) to an entry point followed by a pluralized object name in some cases. In other cases, the request may include a uniform resource locator (URL) to an entry point followed by a pluralized object type name and an object identifier.

Next, the computing device inquires to the IoT API whether the singular form of the resource parameter is a valid object type in an IoT domain (operation 730). If the singular form of the resource parameter is the valid object type, the computing device further retrieves information about a plurality of objects corresponding to the valid object type (operation 740). Then, the computing device generates a response comprising the information about the plurality of objects to the client device (operation 750).

In some implementations, the computing device receives an object type identifier and a link to the plurality of objects in response to inquiring to the IoT API whether the singular form of the resource parameter is a valid object type. Additionally, the computing device retrieves the information about the plurality of objects using the received link. In some implementations, the computing device joins a link corresponding to each object in the plurality of objects in a _links map in the response to the client device.

In some implementations where the resource parameter includes an object identifier, the computing device retrieves information about a particular object corresponding to the object identifier. Further, the computing device determines an object type corresponding to the particular object. Also, the computing device determines whether the object type corresponding to the particular object is same as the valid object type. If so, the computing device generates the response including the information about the particular object corresponding to the object identifier to the client device.

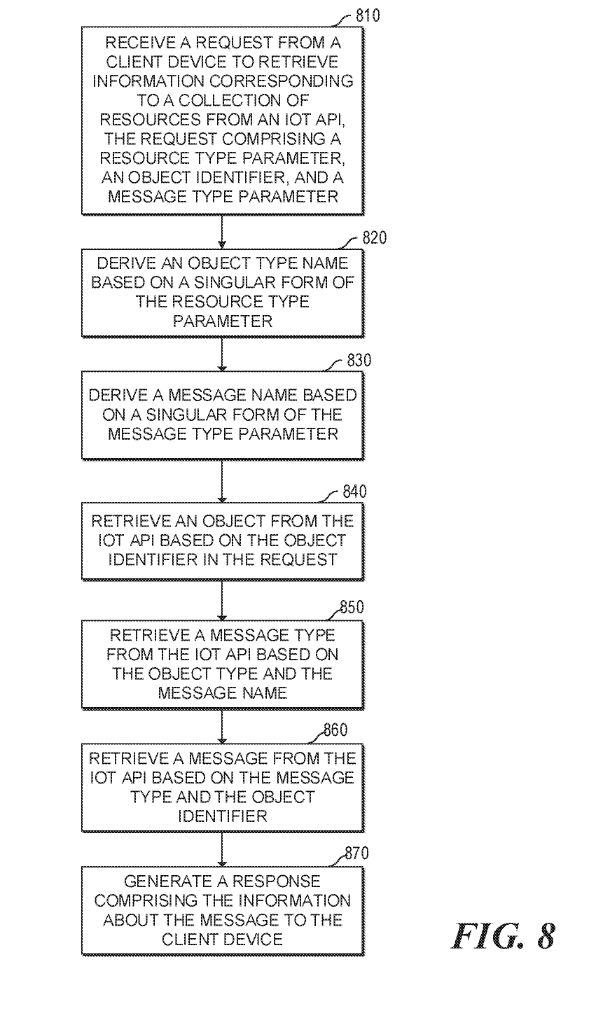

FIG. 8 is a flowchart of an example process to generate a response to a client device of an IoT domain using domain-specific REST controller. First, a computing device (e.g., the domain-specific REST controller) receives a request from a client device to retrieve information corresponding to a collection of resources from an Internet of Things (IoT) Application Programming Interface (API) (operation 810).

The request includes at least a resource type parameter, an object identifier, and a message type parameter. In some examples, the request further includes a message identifier.

In some examples, the request includes a uniform resource locator (URL) to an entry point followed by a pluralized object name, an object identifier, and a pluralized message name. In some examples, the request comprises a uniform resource locator (URL) to an entry point followed by a pluralized object type name, an object identifier, a pluralized message name, and a message identifier.

In some examples, the response includes a nested individual message resource. In some examples, the response includes a collection of nested message resources. For example, the response may include a nested message resource collection joined together in an embedded map.

Then, the computing device derives an object type name based on a singular form of the resource type parameter (operation 820). Also, the computing device derives a message name based on a singular form of the message type parameter (operation 830).

Next, the computing device retrieves an object from the IoT API based on the object identifier in the request (operation 840). Moreover, the computing device retrieves a message type from the IoT API based on the object type and the message name (operation 850). Thereafter, the computing device retrieves a message from the IoT API based on the message type and the object identifier (operation 860). Further, the computing device generates a response including the information about the message to the client device (operation 870).

In some implementations, the computing device verifies whether an object type corresponding to the object matches the object type name derived from the resource type parameter. If the object type corresponding to the object does not match the object type name derived from the resource type parameter, the computing device returns an error message to the client device.

In some implementations, the computing device verifies whether an object type matching the message name exists in the IoT API. If the object type matching the message name does not exist in the IoT API, the computing device returns an error message to the client device.

In some implementations, the computing device verifies whether a message name corresponding to the retrieved message type matches the message name derived from the message type parameter. If the message name corresponding to the retrieved message type does not match the message name derived from the message type parameter, the computing device returns an error message to the client device.

In some implementations, the computing device verifies whether the message corresponding to the message identifier belongs to the object corresponding to the object identifier. If the message corresponding to the message identifier does not belong to the object corresponding to the object identifier, the computing device returns an error message to the client device.

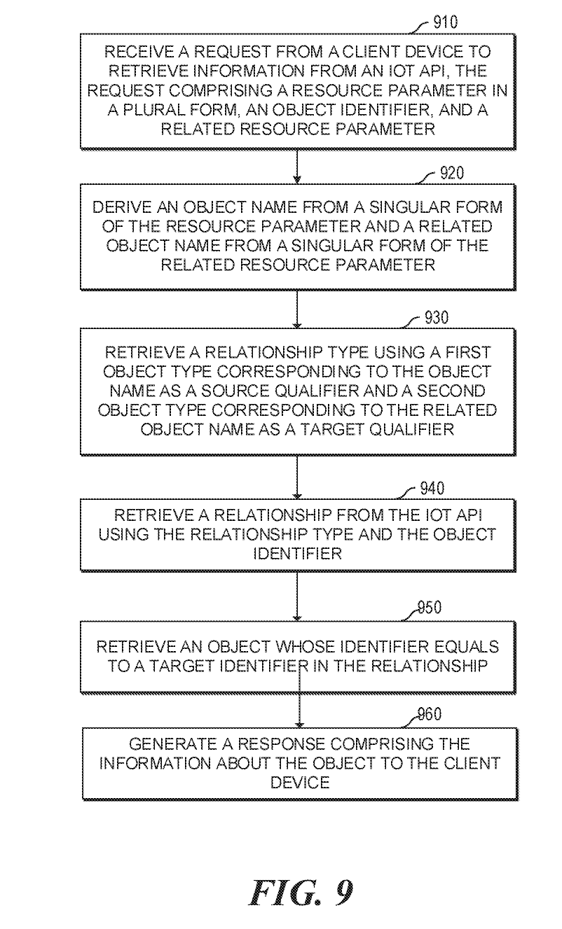

FIG. 9 is a flowchart of an example process to generate a response to a client device of an IoT domain using domain-specific REST controller. First, a computing device (e.g., the domain-specific REST controller) receives a request from a client device to retrieve information from an Internet of Things (IoT) Application Programming Interface (API) (operation 910).

Here, the request includes at least a resource parameter in a plural form, an object identifier, and a related resource parameter.

Then, the computing device derives an object name from a singular form of the resource parameter and a related object name from a singular form of the related resource parameter (operation 920).

Next, the computing device retrieves a relationship type using a first object type corresponding to the object name as a source qualifier and a second object type corresponding to the related object name as a target qualifier (operation 930). Also, the computing device retrieves a relationship from the IoT API using the relationship type and the object identifier (operation 940). Further, the computing device retrieves an object whose identifier equals to a target identifier in the relationship (operation 950). Moreover, the computing device generates a response including the information about the object to the client device (operation 960).

In some implementations, the computing device retrieves an individual object from the IoT API based on the object identifier in the request. Then, the computing device verifies that the object name matches the individual object retrieved based on the object identifier.

In some implementations, the computing device retrieves a plurality of relationships from the IoT API corresponding to the relationship type and the object identifier. Then, the computing device retrieves each individual object whose identifier equals to the target identifier in each of the plurality of relationships. Moreover, the computing device joins the each individual object in an embedded map that is included in the response to the client device.

Also, the computing device can determine whether a cardinality of the relationship equals many. If the cardinality of the relationship does not equal many, the computing device returns a first object in the plurality of objects in the response to the client device.

Network Device to Generate a Response to a Client Device in an IoT Domain

FIG. 10 is a block diagram of an example network device with at least one processor 1010 to execute instructions 1030-1080 within a machine-readable storage medium 1020 to generate a response to a client device in an IoT domain. Although the network device 1000 includes at least one processor 1010 and machine-readable storage medium 1020, it may also include other components that would be suitable to one skilled in the art. For example, network device 1000 may include an additional processing component and/or storage. In another implementation, the networking component (e.g., domain-specific REST controller 105 in FIG. 1) executes instructions 1030-1080. Network device 1000 is an electronic device with the at least one processor 1010 capable of executing instructions 1030-1080, and as such implementations of network device 1000 include a mobile device, server, data center, networking device, client device, computer, or other type of electronic device capable of executing instructions 1030-1080. The instructions 1030-1080 may be implemented as methods, functions, operations, and other processes implemented as machine-readable instructions stored on the storage medium 1020, which may be non-transitory, such as hardware storage devices (e.g., random access memory (RAM), read only memory (ROM), erasable programmable ROM, electrically erasable ROM, hard drives, and flash memory).

The at least one processor 1010 may fetch, decode, and execute instructions 1030-1080 to generate a response to a client device in an IoT domain. Specifically, the at least one processor 1010 executes instructions 1030-1080 to: receive a request from a client device to retrieve information from an IoT API; receive an object type identifier and a link to the plurality of objects in response to inquiring to the IoT API whether the singular form of the resource parameter is a valid object type; derive an object type name based on a singular form of the resource type parameter; derive a message name based on a singular form of the message type parameter; derive an object name from a singular form of the resource parameter; derive a related object name from a singular form of the related resource parameter; inquire to the IoT API whether the singular form of the resource parameter is a valid object type in an IoT domain; retrieve information about a plurality of objects corresponding to the valid object type; retrieve the information about the plurality of objects using the received link; retrieve information about a particular object corresponding to the object identifier; retrieve an object from the IoT API based on the object identifier in the request; retrieve a message type from the IoT API based on the object type and the message name; retrieve a message from the IoT API based on the message type and the object identifier; retrieve a relationship type using a first object type corresponding to the object name as a source qualifier and a second object type corresponding to the related object name as a target qualifier; retrieve a relationship from the IoT API using the relationship type and the object identifier; retrieve an object whose identifier equals to a target identifier in the relationship; retrieve a plurality of relationships from the IoT API corresponding to the relationship type and the object identifier; retrieve each individual object whose identifier equals to the target identifier in each of the plurality of relationships; determine an object type corresponding to the particular object; determine whether the object type corresponding to the particular object is same as the valid object type; generate a response including the information about a plurality of objects to the client device; join the each individual object in an embedded map that is included in the response to the client device; generate the response including the information about a particular object corresponding to the object identifier to the client device; generate a response including the information a message to the client device; verify that the object name matches the individual object retrieved based on the object identifier; verify that an object type corresponding to the object matches the object type name derived from the resource type parameter; verify that an object type matching the message name exists in the IoT API; verify that a message name corresponding to the retrieved message type matches the message name derived from the message type parameter; verify that the message corresponding to the message identifier belongs to the object corresponding to the object identifier; return an error message to the client device; determine whether a cardinality of the relationship equals to many; return a first object in the plurality of objects in the response to the client device in response to the cardinality of the relationship not equaling to many; etc.

The machine-readable storage medium 1020 includes instructions 1030-1080 for the processor 1010 to fetch, decode, and execute. In another example, the machine-readable storage medium 1020 may be an electronic, magnetic, optical, memory, storage, flash-drive, or other physical device that contains or stores executable instructions. Thus, the machine-readable storage medium 1020 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 1020 may include an application and/or firmware which can be utilized independently and/or in conjunction with the at least one processor 1010 to fetch, decode, and/or execute instructions of the machine-readable storage medium 1020. The application and/or firmware may be stored on the machine-readable storage medium 1020 and/or stored on another location of the network device 1000.

We claim:

1. A method comprising:
receiving, by a computing device, a request from a client device to retrieve information from an Internet of Things (IoT) Application Programming Interface (API), the request comprising a resource parameter in a plural form;
deriving, by the computing device, a singular form of the resource parameter;
inquiring, by the computing device, to the IoT API whether the singular form of the resource parameter is a valid object type in an IoT domain;
in response to the singular form of the resource parameter being the valid object type, retrieving, by the computing device, information about a plurality of objects corresponding to the valid object type; and
generating, by the computing device, a response comprising the information about the plurality of objects to the client device.

2. The method of claim 1, further comprising:
receiving an object type identifier and a link to the plurality of objects in response to inquiring to the IoT API whether the singular form of the resource parameter is a valid object type; and
retrieving the information about the plurality of objects using the received link.

3. The method of claim 1, wherein the IoT API comprises a generic IoT API, and wherein the resource parameter comprises a pluralized object type name.

4. The method of claim 1, wherein the resource parameter comprises an object identifier, and wherein the method further comprises:
retrieving information about a particular object corresponding to the object identifier;
determining an object type corresponding to the particular object;
determining whether the object type corresponding to the particular object is same as the valid object type; and
generating, by the computing device, the response comprising the information about the particular object corresponding to the object identifier to the client device.

5. The method of claim 1, further comprising:
joining, by the computing device, a link corresponding to each object in the plurality of objects in a _links map in the response to the client device.

6. The method of claim 1, wherein the request comprises a uniform resource locator (URL) to an entry point followed by a pluralized object name.

7. The method of claim 1, wherein the request comprises a uniform resource locator (URL) to an entry point followed by a pluralized object type name and an object identifier.

8. A system comprising:
a memory;
a hardware processor executing instructions in the memory to:
receive a request from a client device to retrieve information corresponding to a collection of resources from an Internet of Things (IoT) Application Programming Interface (API), the request comprising a resource type parameter, an object identifier, and a message type parameter;
derive an object type name based on a singular form of the resource type parameter;
derive a message name based on a singular form of the message type parameter;
retrieve an object from the IoT API based on the object identifier in the request;
retrieve a message type from the IoT API based on the object type and the message name;
retrieve a message from the IoT API based on the message type and the object identifier; and
generate a response comprising the information about the message to the client device.

9. The system of claim 8, wherein the hardware processor further executing instructions in the memory to:
verify that an object type corresponding to the object matches the object type name derived from the resource type parameter; and
in response to the object type corresponding to the object not matching the object type name derived from the resource type parameter, return an error message to the client device.

10. The system of claim 8, wherein the hardware processor further executing instructions in the memory to:
verify that an object type matching the message name exists in the IoT API; and
in response to the object type matching the message name not existing in the IoT API, return an error message to the client device.

11. The system of claim 8, wherein the response comprises a nested message resource collection joined together in an embedded map.

12. The system of claim 11, wherein the request comprises a uniform resource locator (URL) to an entry point followed by a pluralized object name, an object identifier, and a pluralized message name.

13. The system of claim 8, wherein the request further comprises a message identifier, and wherein the response comprises a nested individual message resource.

14. The system of claim 13, wherein the request comprises a uniform resource locator (URL) to an entry point followed by a pluralized object type name, an object identifier, a pluralized message name, and a message identifier.

15. The system of claim 13, wherein the hardware processor further executing instructions in the memory to:
verify that a message name corresponding to the retrieved message type matches the message name derived from the message type parameter; and
in response to the message name corresponding to the retrieved message type not matching the message name derived from the message type parameter, return an error message to the client device.

16. The system of claim 13, wherein the hardware processor further executing instructions in the memory to:
verify that the message corresponding to the message identifier belongs to the object corresponding to the object identifier; and
in response to the message corresponding to the message identifier not belonging to the object corresponding to the object identifier, return an error message to the client device.

17. A non-transitory machine-readable storage medium encoded with instructions executable by at least one processor of a network device, the machine-readable storage medium comprising instructions to:
receive a request from a client device to retrieve information from an Internet of Things (IoT) Application Programming Interface (API), the request comprising a resource parameter in a plural form, an object identifier, and a related resource parameter;
derive an object name from a singular form of the resource parameter and a related object name from a singular form of the related resource parameter;
retrieve a relationship type using a first object type corresponding to the object name as a source qualifier and a second object type corresponding to the related object name as a target qualifier;
retrieve a relationship from the IoT API using the relationship type and the object identifier;
retrieve an object whose identifier equals to a target identifier in the relationship; and
generate a response comprising the information about the object to the client device.

18. A non-transitory machine-readable storage medium of claim 17, further comprising instructions to:
retrieve an individual object from the IoT API based on the object identifier in the request;
verify that the object name matches the individual object retrieved based on the object identifier.

19. A non-transitory machine-readable storage medium of claim 17, further comprising instructions to:
retrieve a plurality of relationships from the IoT API corresponding to the relationship type and the object identifier;
retrieve each individual object whose identifier equals to the target identifier in each of the plurality of relationships;
join the each individual object in an embedded map that is included in the response to the client device.

20. A non-transitory machine-readable storage medium of claim 19, further comprising instructions to:
determine whether a cardinality of the relationship equals to many; and
in response to the cardinality of the relationship not equaling to many, return a first object in the plurality of objects in the response to the client device.
